(19) United States
(12) Patent Application Publication
(10) Pub. No.: US 2024/0192701 A1
(43) Pub. Date: Jun. 13, 2024

(54) Method and System for Robot Navigation in Unknown Environments

(71) Applicant: Cambridge Enterprise Limited, Cambridge (GB)

(72) Inventors: Amanda Prorok, Cambridge (GB); Zhe Liu, Shanghai (CN); Jan Blumenkamp, Cambridge (GB); Binyu Wang, Zibo (CN)

(21) Appl. No.: 18/287,686

(22) PCT Filed: Apr. 29, 2022
(86) PCT No.: PCT/GB2022/051099

§ 371 Date: Oct. 20, 2023

(30) Foreign Application Priority Data
Apr. 30, 2021 (GB) 2106286.4

(51) Int. Cl. G05D 1/644; G05D 1/646; G05D 101/15; G05D 111/10; G06V 10/80; G06V 10/82

(52) U.S. Cl. CPC G05D 1/644; G05D 1/646; G06V 10/806; G06V 10/82; G05D 2101/15; G05D 2111/10

(57) ABSTRACT

Broadly speaking, embodiments of the present techniques provide methods and systems for robot navigation in an unknown environment. In particular, the present techniques provide a navigation system comprising a navigating device and a sensor network comprising a plurality of static sensors. The sensor network is trained to predict a direction to a target object, and the navigating device is trained to reach the target object as efficiently as possible using information obtained from the sensor network.

### FIELD

The present techniques generally relate to a method and system for robot navigation in an unknown environment. In particular, the present techniques provide a method for training a machine learning, ML, model for enabling a robot or navigating device to navigate through an unknown environment to a target object using input from a network of sensors, and a navigation system that uses a trained ML model to guide the robot/navigating device to a target object.

### BACKGROUND

Efficiently finding and navigating to a target in complex unknown environments is a fundamental robotics problem, with applications to search and rescue and environmental monitoring. Recently, solutions which use low-cost wireless sensors to guide robotic navigation have been proposed. These show that at a small additional cost (i.e. the deployment of cheap static sensors with local communication capabilities), the requirements on the capabilities of the robot can be significantly reduced while simultaneously improving the robot's navigation efficiency.

However, the implementation of traditional sensor-network guided navigation is cumbersome. Typically, this process consists of five main steps: (1) estimate robot and sensor positions through external systems such as GPS or anchors; (2) pre-process the sensor data to detect the target; (3) transmit the target information to the robot; (4) build the environmental map and plan a path to the target; and (5) compute control commands based on a pre-formulated dynamic model to allow the robot to follow the path while avoiding obstacles. This framework has several drawbacks. Firstly, parameters need to be hand-tuned, and several data pre-processing steps are required. Secondly, isolating the perception, planning, and control modules hinder potential positive feedback among them, and make the modelling and control problems challenging.

Background information can be found in: Qun Li et al, “Distributed algorithms for guiding navigation across a sensor network”, Proceedings of the Ninth Annual International Conference on Mobile Computing and Networking (MOBICOM 2003), 2003, pages 313-325. Qun Li et al discloses distributed algorithms for self-reconfiguring sensor networks that respond to directing a target through a region, where the algorithm uses the artificial potential field of sensors to guide an object through the network to a goal.

The present applicant has therefore identified the need for an improved mechanism for robot navigation in unknown environments.

### SUMMARY

In a first approach of the present techniques, there is provided a computer-implemented method of training a machine learning, ML, model for a navigation system comprising a navigating device and a sensor network comprising a plurality of static sensors that are communicatively coupled together, the method comprising: training neural network modules of a first sub-model of the ML model to predict, using data captured by the plurality of static sensors, a direction corresponding to a shortest path to a target object, wherein the target object is detectable by at least one static sensor; and training neural network modules of a second sub-model of the ML model to guide, using information received from the plurality of static sensors, the navigating device to the target object.

The present techniques provide a learning approach to visual navigation guided by a sensor network, which overcome the problems described above. Successful navigation requires the robot to learn the relationship between its surrounding environment, raw sensor data, and its actions. To enable this, the present techniques provide a way to train a static sensor network to guide a navigating device to the target. The term “navigating device” is used interchangeably herein with the term “navigating robot” and “robot”. The navigating device may be a controlled/controllable or autonomous navigating robot, that is able to move through an environment towards the target. Alternatively, the navigating device may be a device that could be held or worn by a human user and used by the human user to move towards a target object.

As will be explained in more detail below, the present techniques provide a two-stage approach to training the machine learning, ML, model to be used by a navigation system. In the first stage, the sensor network is trained. The aim of the training is to predict, for each sensor in the sensor network, a direction to the target object. The training uses data captured by each sensor and inter-sensor communication. In the second stage, the robot is trained. The aim of the training in this case is to train the robot to reach the target object as efficiently as possible by using data captured by the robot itself and information communicated to the robot by the sensor network. This two-stage approach is advantageous because it does not require auxiliary tasks or learning curricula to be used in the learning process. Instead, the two-stage approach is used to directly learn what is needed to be communicated to the navigating robot. Furthermore, the two-stage approach is advantageous because it does not require any global positioning information of the sensors, target or robot. Another advantage is that it does not require a pre-calibration process for the sensor network and so can be easily implemented in new environments.

Neither the robot nor the sensors know anything about the target object (e.g. what the target object looks like, or sounds like, or smells like, etc.). Instead, this information is also learned by the ML model. A component of the ML model (which may be a component that is part of and/or used during the first stage of the training process), may be used to learn what the target object is. Once this component has determined what the target object is, the target object knowledge can be utilised by the sensor network and the navigating device. This component may be straightforward to train and replace because the ML model is modular. The remainder of (e.g. the communicative part of) the ML model is target-agnostic. In other words, since only the ground-truth direction information is needed in the learning process, it is not necessary to know exactly what the target object is or looks like. This information is learnt by the network itself from labelled target direction information. This is advantageous because the trained navigation system may then be deployed in a wide variety of environments and used for different applications, without requiring retraining. For example, the trained navigation system may be used to perform search and rescue operations, to navigate within a structured environment such as a warehouse, to identify and navigate towards people of interest within an airport, or to survey an environment that cannot be easily accessed by humans. In each case, the sensors and robot may be deployed in an environment, and the system identifies, using the trained ML model, what may be a target object in that environment.

The sensor network is trained using data captured by each static sensor in the sensor network. The target object is detectable by at least one static sensor. In some cases, the target object may be detectable by a static sensor if the target object is in close proximity to the static sensor. In cases where the static sensors are visual sensors, the target object may be detectable if it is in line-of-sight of at least one static sensor. Information about the target object obtained by the or each static sensor that is able to detect the target object is shared with other sensors of the sensor network that are in communication range. This enables each sensor to predict the direction to the target object from the sensor's own location. Thus, the plurality of static sensors in the sensor network are communicatively coupled together. In particular, a communication topology of the plurality of static sensors in the sensor network is connected. This means that a communication path exists between each sensor and every other sensor. The communication path is not necessarily direct. Instead, information may be transmitted from one sensor to another via intermediate (relay) sensors using, e.g. multi-hop routing.

The sharing of data captured by each static sensor enables each sensor in the sensor network to be endowed with policies that are learnt through a machine learning architecture that leverages Graph Neural Networks (GNN). Thus, training the neural network modules of the first sub-model to predict the direction may comprise extracting information from the data captured by each static sensor in the sensor network. The extracted information may be used to predict, using a graph neural network, GNN, module of the first sub-model, the direction corresponding to the shortest obstacle-free path to the target object.

The method may comprise defining a set of various-hop graphs representing relations between the static sensors of the sensor network, where each graph of the set of graphs shows how each static sensor is connected to other static sensors that are a predefined number of hops away.

The GNN module may comprise graph convolutional layer, GCL, sub-modules. Using a GNN module to predict the direction may comprise: aggregating, using the GCL sub-modules, the extracted information obtained from data captured by the static sensors in each various-hop graph; and concatenating the extracted information and the aggregated extracted information for each static sensor.

The static sensors of the sensor network may be any suitable type of sensor. Preferably, the static sensors are all of the same type, so that each sensor can understand and use the data obtained from the other sensors. For example, the static sensors may be audio or sound based sensors. In another example, the static sensors may be visual sensors. Any type of static sensor may be used, as long as the target object is detectable by at least one of the static sensors using its sensing capability.

In the case where the plurality of static sensors are visual sensors which capture image data, the target object is in line-of-sight of at least one static sensor. The step of extracting information may comprise performing feature extraction on image data captured by the plurality of static sensors, using a convolutional neural network, CNN, module of the first sub-model. In this case, aggregating the extracted information may comprise aggregating features extracted from images captured by neighbouring static sensors, and extracting fused features from the images of each sensor, using the GNN module of the first sub-model. The concatenating step may comprise concatenating the extracted features and the aggregated features for each sensor.

It will be understood that the architecture of the ML model and the way the target direction prediction is performed may change based on the static sensors being non-visual sensors. That is, the above steps may change based on the type of data collected by the static sensor.

The method may further comprise inputting the concatenation for each static sensor into a multi-layer perceptron, MLP, module of the first sub-model; and outputting, from the MLP module, a two-dimensional vector for each static sensor which predicts the direction corresponding to the shortest obstacle-free path from the static sensor to the target object.

As mentioned above, the two-stage approach of the present techniques requires the process to train the neural network modules of the second sub-model (to guide the navigating robot) to be performed after the process to train the neural network modules of the first sub-model (to predict the direction).

Thus, after the first sub-model has been trained, the method may comprise: initialising parameters of the second sub-model using the trained neural network modules of the first sub-model and by considering the navigating device to be an additional sensor within the first sub-model; and applying reinforcement learning to train the second sub-model to guide the navigating device to the target object.

Applying reinforcement learning may comprise using the predicted direction to reward the navigating device, at each time step, to move in a direction corresponding to the predicted direction. That is, the reinforcement learning encourages the navigating device to move towards the target object at each time step.

Training in the real-world is generally unfeasible due to the difficulty in obtaining sufficient training data and due to sample-inefficient learning algorithms. Thus, the training described herein may be performed with non-photorealistic simulators. However, photorealistic simulations are challenging to realise and expensive. As a result, a model trained in a non-photorealistic simulator may not function correctly or as accurately when the trained model is deployed in the real-world. Thus, the present techniques also provide a technique to facilitate the transfer of the policy trained in simulation directly to a real navigating device to be deployed in the real world. Advantageously, this means that the whole model does not need to be retrained when the navigation system is deployed in the real world, which can speed-up the time to prepare the system for real world use.

Thus, the neural network modules of the first and second sub-models may be trained in a simulated environment.

The method may further comprise training a transfer module using a training dataset comprising a plurality of pairs of data, each pair of data comprising data from a static sensor in the simulated environment and data from a static sensor in a corresponding real world environment.

Once the transfer module has been trained, the method may further comprise replacing one or more of the neural network modules of the first sub-model of using corresponding neural network modules of the transfer module. In this way, the neural network modules that have been trained using real-world data are swapped in for the neural network modules that have been trained in the simulation, and the navigating device can be deployed with improved chances of navigating through a real-world environment.

In a second approach of the present techniques, there is provided a navigation system comprising: a sensor network comprising a plurality of static sensors, wherein each static sensor comprises a processor, coupled to memory, arranged to use a trained first sub-model of a machine learning, ML, model to: predict a direction corresponding to a shortest path to a target object, wherein the target object is detectable by least one static sensor; a navigating device comprising a processor, coupled to memory, arranged to use a trained second sub-model of the machine learning, ML, model to: guide the navigating device to the target object using information received from the plurality of static sensors.

The plurality of static sensors in the sensor network are communicatively coupled together. Each static sensor is unable to predict a direction from the static sensor to the target object using its own observations only. Therefore, preferably, a communication topology of the plurality of static sensors in the sensor network is connected.

Each static sensor is able to transmit data captured by the static sensor to other static sensors in the sensor network. This enables each static sensor to predict a direction from the static sensor to the target object. In some cases, the data transmitted by the static sensor to other sensors in the sensor network is raw sensor data captured by the static sensor. Preferably, particularly in the case of visual sensors where the data captured by the sensors may have a large file size that may not be efficient to transmit, the data transmitted by the static sensor may be processed data. For example, in the case of visual sensors, features may be extracted from the images captured by the sensors, and the extracted features are transmitted to other sensors. This increases efficiency and avoids redundant information being transmitted.

The navigating device is communicatively coupled to at least one static sensor while the navigating device moves towards the target object. In other words, the navigating device is able to communicate with the sensor network. The navigating device may obtain information from at least one static sensor (e.g. a static sensor that is in communication range with the navigating robot). From this information, the navigating device may learn the direction from its own position to the target object. This enables the navigating device to determine which direction it needs to move in. In this way, the navigating device is guided by the information received from each static sensor towards the target object.

The plurality of static sensors may be visual sensors capturing image data. The target object is in line-of-sight of at least one static sensor.

The sensor network comprises a plurality of static sensors. The exact number of static sensors may vary depending on the size of the environment to be explored by the navigation system and the communication range of each sensor, for example.

In a related approach of the present techniques, there is provided a non-transitory data carrier carrying processor control code to implement any of the methods, processes and techniques described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be implemented using multiple processors or control circuits. The present techniques may be adapted to run on, or integrated into, the operating system of an apparatus.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

### BRIEF DESCRIPTION OF THE DRAWINGS

Implementations of the present techniques will now be described, by way of example only, with reference to the accompanying drawings, in which:

FIGS. 1A to 1C are schematic diagrams showing the two-stage approach of the present techniques;

FIG. 2 shows an example of an omnidirectional image captured by a navigating device;

FIG. 3 is a schematic diagram showing the structure of the machine learning, ML, model;

FIG. 4 is a schematic diagram of the graph neural network module;

FIG. 5 illustrates the loss function of the first stage and reward function of the second stage;

FIG. 6 shows example maps and sensor layouts used to train the ML model;

FIG. 7 is a table showing an average angle error of all the sensors in each unseen map of the target prediction task;

FIG. 8 is a table showing an average angle error of the robot in each unseen map of the target prediction task;

FIG. 9 is a graph comparing the training loss with and without dynamic training;

FIG. 10 is a graph comparing the training loss with and without graph attention networks, GAT;

FIG. 11 is a table showing the results of robot navigation;

FIG. 12 is a graph comparing the training reward provided in the second stage;

FIG. 13 is a visualisation for interpreting robot control policy;

FIG. 14 illustrates a case where a robot is unable to communicate with the sensor network;

FIG. 15A is a flowchart of example steps to train the ML model for the navigation system;

FIG. 15B is a flowchart of example steps to train a transfer module;

FIG. 15C is a schematic diagram illustrating the training of FIG. 15B; and

FIG. 16 is a block diagram of the navigation system.

### DETAILED DESCRIPTION OF THE DRAWINGS

Broadly speaking, embodiments of the present techniques provide methods and systems for robot navigation in an unknown environment. In particular, the present techniques provide a navigation system comprising a navigating device and a sensor network comprising a plurality of static sensors. The sensor network trained to predict a direction to a target object, and the navigating device is trained to reach the target object as efficiently as possible using information obtained from the sensor network.

Sensor network-guided robot navigation has received substantial attention in the last decade. Traditional approaches assume that either the robot, or a subset of the sensors, has global position information, based on which, the shortest multi-hop route from the robot to the sensor which is closest to the target can be obtained. Recently, Deep Learning (DL)-based methods have been proposed to solve the sensor network localisation and mobile agent tracking problem. Similar to the former conventional methods, DL-based methods also assume that several sensors have known location information, which limits the generalisability of such methods.

A graph neural network, GNN, represents an effective method to aggregate and learn from relational, non-Euclidean data. GNN-based methods have achieved promising results in numerous domains, including human behaviour recognition and vehicle trajectory prediction. The commonality of these prior approaches is that they focus on predicting global information by using a centralized framework that aggregates all the information. Recently, distributed methods have been studied in the multirobot domain. For example, a fully decentralized framework has been proposed to solve the multi-robot path-planning problem, in which GNNs offer an efficient architecture to facilitate local motion coordination. However, this approach can only be used with birds-eye-view observations. A vision-based decentralized method has been proposed to solve the flocking problem. First-person-view images are used to estimate the state of neighbours, and a GNN is introduced for feature aggregation. However, this method needs to pre-train the perception network with handcrafted features. Advantageously, pre-training of the perception network is not required by the present techniques.

Additionally, both aforementioned approaches rely on imitation learning with expert datasets, which can limit their generalizability. A reinforcement learning, RL, based method has been proposed which uses GNNs to elicit adversarial communications to address the case where agents have self-interested objectives. However, this method also has not taken first-person-view observations into consideration.

One of the most challenging issues in visual navigation is how to learn efficient features from the raw sensor data. Directly training the whole network end-to-end does not circumvent low sample efficiency. Hence, most existing works train the perception and control modules separately and then fine-tune the whole network. Auxiliary tasks, such as depth estimation and reward prediction, are usually introduced to increase the feature extraction ability of the perception module. In addition, the curriculum learning strategy is also effective in overcoming low sample efficiency and reward sparsity. Advantageously, in contrast to prior work, the present techniques consider a novel problem formulation in which the navigating robot is guided by a visual sensor network by aggregating its own observations with information obtained through network messages. Instead of introducing auxiliary tasks or learning curricula, a joint training scheme is used to directly learn what information needs to be communicated and how to aggregate the communicated information to ensure efficient navigation in unknown environments.

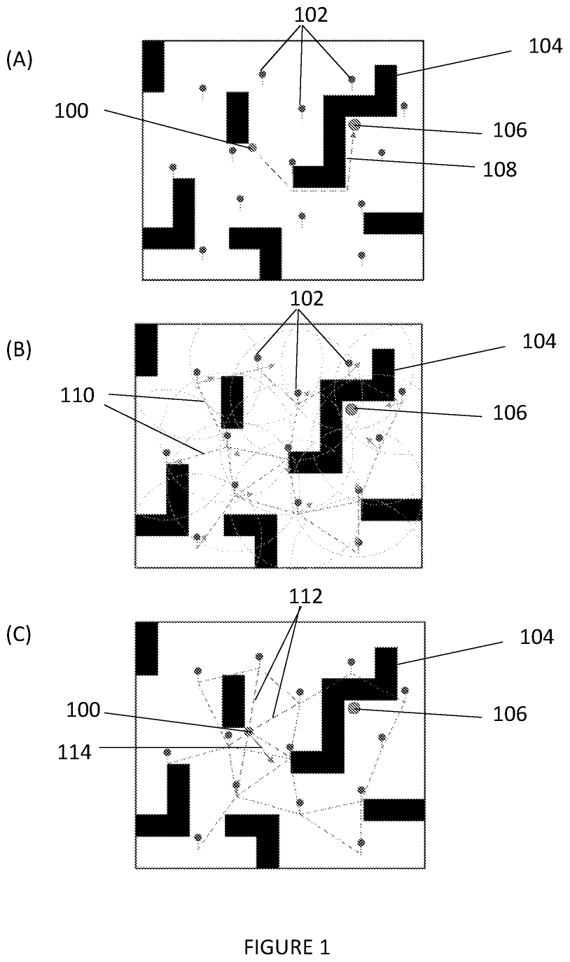

FIGS. 1A to 1C show the two-stage approach of the present techniques. The present techniques provide a learning approach to visual navigation guided by a sensor network. The nodes in this sensor network are endowed with policies that are learnt through a machine learning architecture that leverages Graph Neural Networks (GNN). Successful navigation requires a navigating device to learn the relationship between its surrounding environment, raw sensor data, and its actions. The navigating device may be a controlled or autonomous navigating robot, or may be a navigating device that could be held or worn by a human and used by the human to move towards a target object. The term “navigating device” is used interchangeably herein with the term “navigating robot” and “robot”.

This makes first-person-view-based navigation well suited to deep Reinforcement Learning (RL). Yet the main challenge with such RL methods is that they suffer from reward sparsity and low sample efficiency. Current solutions include auxiliary tasks and curriculum learning strategies.

The present techniques provide a complementary approach by introducing a static visual sensor network that is capable of learning to guide a navigating device to the target object. As shown in FIGS. 1A to 1C, the present techniques provide a two-stage approach to training the machine learning, ML, model to be used by a navigation system.

As shown in FIG. 1A, the present techniques consider the robot navigation problem in an unknown environment with the help of a sensor network. The navigation system comprises a navigating device 100, and a sensor network comprising a plurality of static sensors 102. The navigation system is trained to enable the navigating device 100 to navigate towards a target object 106. As shown in FIG. 1A, there are a number of static obstacles 104 in the system, which the navigating device 100 also needs to navigate around in order to navigate towards the target object 106. The static obstacles 104 also prevent the navigating device 100 and some static sensors 102 from being able to see or detect the target object 106, and prevent some static sensors 102 from being detectable by the navigating device 100. Dashed line 108 indicates an expected optimal path from the current position of the navigating device 100 to the target object 106. The target object 106 is detectable by at least one static sensor 102.

FIG. 1B shows the first stage (Stage 1) of the two-stage approach to training the machine learning, ML, model to be used by a navigation system. In the first stage, the sensor network comprising the plurality of static sensors 102, is trained. The objective of the first stage is to predict a direction to the target object 106 at each static sensor 102 by using data collected by each static sensor 102 and inter-sensor communication. For this reason, the navigating device 100 is not part of this stage of the training.

In cases where each static sensor 102 is a visual sensor, the data collected by each static sensor 102 may be first-person-view raw image data. In such cases, the target object 106 is in line-of-sight of at least one static sensor 102.

Dotted lines 110 represent the communication link among the static sensors 102. Each static sensor 102 predicts a direction which corresponds to the shortest obstacle-free path to the target object 106. The predicted direction is shown by the short arrow extending from each static sensor 102 in FIG. 1B.

FIG. 1C shows the second stage (Stage 2) of the two-stage approach to training the machine learning, ML, model to be used by a navigation system. In the second stage, the navigating device 100 is trained. The objective of the second stage is for the navigating device 100 to reach the target object 106 as efficiently as possible by using its own visual input as well as information communicated by the network of static sensors 102. Instead of introducing auxiliary tasks or learning curricula, the present techniques use this two-stage learning method to directly learn what needs to be communicated to the navigating device 100. Dashed lines 112 represent the communication links between the navigating device 100 and neighbouring (i.e. detectable) static sensors 102 which are in the communication rage of the navigating device 100. In Stage 2, an RL-based planner may be used to generate navigation instructions (indicated by arrow 114 extending from the navigating device 100) that enables the navigating device 100 to navigate towards the target object 106 with the minimum detour guided by the information provided by the static sensors 102.

An advantage of the two-stage training approach includes using low-cost sensor networks to help robots navigate unknown environments without any positioning information (e.g. GPS information). Another advantage is the provision of a deep RL scheme for first-person-view visual navigation. In particular, a GNN is successfully implemented to learn what needs to be communicated and how to aggregate the information for effective navigation. Furthermore, the generalizability and scalability of the present techniques is validated to unseen environments and sensor layouts, demonstrating the efficiency of the information sharing and aggregation in the network by interpreting the robot control policy, and showing the robustness against temporary communication disconnections.

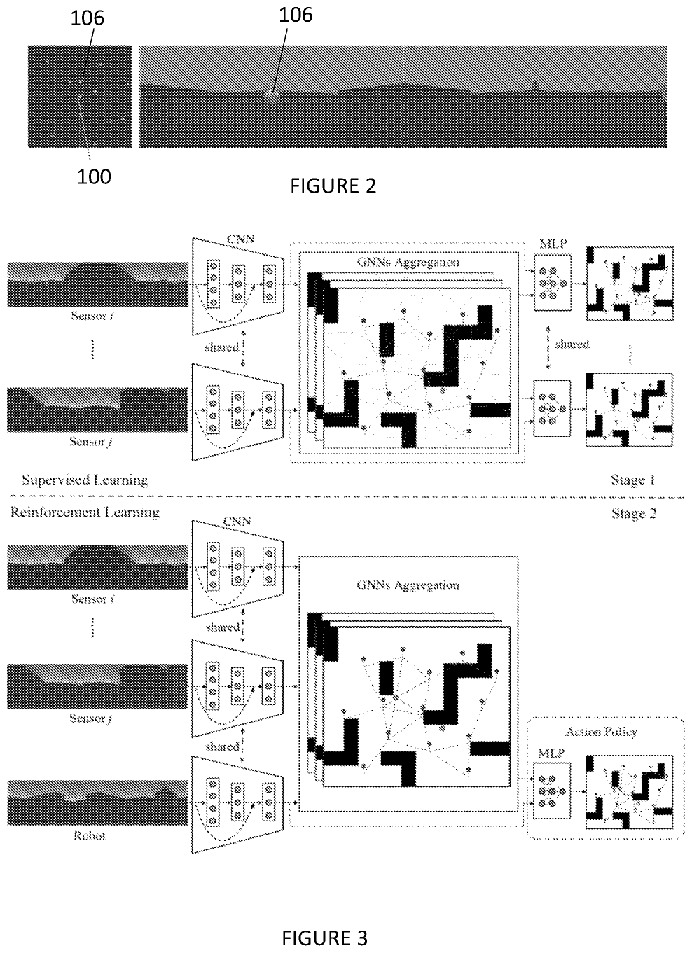

FIG. 2 shows an example of an omnidirectional image captured by a navigating device 100. The left-hand side image shows a plan view of a system in which the navigating device 100 and target object 106 are shown. The right-hand side image shows an image captured by the navigating device 100, which shows that the target object 106 is visible to the navigating device 100.

Problem. Consider a 3D continuous environment [symbol] , which contains a set of static obstacles [symbol] ⊂ [symbol] . There are N static sensors [symbol] ={sᵢ, . . . ,s_{N}} which are randomly located in a 2D horizontal plane (with the height of Hₛ) in the environment. As shown in FIG. 2, each sensor sᵢ can obtain an omnidirectional RGB image oₜ^{Si} of its surrounding environment. Also, each sensor sᵢ can communicate with sⱼ∈ [symbol] ᵢ^{s}, where [symbol] ᵢ^{s} is the neighbor set of sᵢ defined as [symbol] ᵢ^{s}={sⱼ|L(sᵢ,sⱼ)≤Dₛ}, where L(sᵢ,sⱼ) is the Euclidean distance between sᵢ and sⱼ, and Dₛ is the communication range. Since directly transmitting visual images may inevitably cause prohibitive bandwidth load and latency, the messages communicated among sensors are compact features in our approach. Consider a mobile robot r which moves in the 2D ground plane in [symbol] \ [symbol] . At each time t, the robot obtains an omnidirectional RGB image oₜ^{R} of its surrounding environment and communicates with its neighboring sensors sᵢ∈ [symbol] ^{R}, where the robot neighbor set is [symbol] ^{R}={sᵢ|L(r,sᵢ)≤Dₛ}. A target is located randomly in the 2D ground plane. The robot is tasked to find and navigate to the target as quickly as possible.

Assumptions. i) The communication links among the sensors or between the robot and its neighboring sensors are not blocked by any static obstacles. ii) The communication topology of the sensor network is connected and the robot can communicate with at least one sensor at any given time. iii) At each time, all the communications among the sensors or between the robot and its neighboring sensors are achieved synchronously with several rounds, and time delay during communications is not considered. iv) The target is within line-of-sight of at least one sensor, but both the robot and sensors do not know what the target looks like, i.e., this information should be learned by the model itself. v) There are no dynamic obstacles. iv) The local coordinates of the robot and all the sensors are aligned, i.e., their local coordinates have the same fixed x-axis and y-axis directions. Knowledge of the global or relative positioning of the robot or sensors is not assumed.

Robot Action. The robot is velocity-controlled, i.e., the action at time t is defined as aₜ=[Δxₜ,Δyₜ], which is normalized by Δxₜ∈(−1,1) and Δyₜ∈(−1,1).

Objective. Given a local first-person-view visual observation oₜ^{R} and the information obtained from the sensor network, the objective of the approach of the present techniques is to output an action aₜ that enables the robot to move to the target as efficiently as possible.

### A. System Framework

FIG. 3 is a schematic diagram showing the structure of the machine learning, ML, model. As outlined above, the overall system framework of the present techniques contains two main stages. In the first stage, only the sensor network is considered and supervised learning is utilised to predict the target object direction. That is, the first stage comprises training neural network modules of a first sub-model of the ML model to predict, using data captured by the plurality of static sensors 102, a direction corresponding to a shortest path to a target object 106. It will be understood that the shortest path is the shortest obstacle-free path. That is, the shortest path will likely involve navigating around any static obstacles in the environment. The target object 106 is detectable by at least one static sensor 102. In the second stage, the navigating device 100 is introduced, and reinforcement learning is applied to train the model used by the navigating device 100 for the navigation task. That is, the second stage comprises training neural network modules of a second sub-model of the ML model to guide, using information received from the plurality of static sensors 102, the navigating device 100 to the target object 106. These two stages are now discussed in more detail.

Stage 1: Target direction prediction. In this stage, only the sensor network is considered. A supervised learning framework is used. The objective of each static sensor sᵢ is to predict a direction which corresponds to the shortest path to the target object (with the consideration of static obstacles 104) by using its own observation oₜ^{si} and the information shared from other sensors 102. There are three main modules in this stage. These three modules are described with respect to static sensors being visual sensors. It will be understood that these modules may change slightly based on the static sensors being non-visual sensors.
1. Local feature extraction. First, a CNN module is used to extract features zₜ^{si} from the input omnidirectional image oₜ^{si} captured by each sensor sᵢ. The CNN layers of each sensor share the same structure and parameters.
2. Features aggregation. A GNN module is introduced to aggregate neighbors' features and extract fused features of each sensor sᵢ.
3. Target direction prediction. Finally, a skip-connection is used to concatenate the CNN-extracted features to the GNN-aggregated features and then utilize fully connected (FC) layers with shared parameters among all sensors to predict the direction corresponding to the shortest obstacle-free path from each sensor to the target.

Stage 2: Sensor network guided robot navigation. In this stage, RL is used to navigate a navigating device 100 by using its own observations with information obtained through network messages. Specifically, the navigating device 100 is first treated as an additional sensor with the same model structure, and both the pre-trained CNN and GNN layers in Stage 1 are transferred. Then, the follow-up FC layers are randomly initialised to act as the policy network of the navigating device 100. Finally, RL is applied to train the whole model for the navigation task. The information of the shortest path to the target is used in our reward function to encourage the robot to move to the target direction at each time step.

### B. GNN-Based Feature Aggregation

The feature aggregation task of the present techniques is more challenging than the traditional GNN-based feature aggregation for information prediction or robot coordination tasks. Specifically, in existing techniques, each agent only needs to aggregate information from the nearest few neighbors as their tasks can be achieved by only considering local information. For each agent, information contributed by a very remote agent towards improving the prediction performance is typically very small. However, in the feature aggregation task of the present techniques, only a limited number of sensors can directly ‘see’ the target. Yet, crucially, information about the target from these sensors should be transmitted to the whole network, thus enabling all the sensors to predict the target direction from their own location. In addition, as no global or relative pose information is introduced, in order to predict the target direction, each sensor should learn the ability to estimate the relative pose to its neighbors by aggregating image features. Furthermore, generating an obstacle-free path in the target direction by only using image features (without knowing the map) is also very challenging.

In order to achieve the feature aggregation task of the present techniques, each sensor requires effective information from the sensors that can directly see the target. Typically, there are two main strategies to extend the receptive field of each agent. The first one introduces the graph shift operation to collect a summary of the information in a K-hop neighborhood by means of K communication exchanges among 1-hop neighbors and further uses multiple graph convolution layers for feature aggregation. However, this introduces a large amount of redundant information and suffers from overfitting on local neighborhood structures. The second strategy aggregates the information of neighbors located in each hop directly and then mixes the aggregated information over various hops. This strategy can eliminate redundant information and directly aggregate original features from remote neighbors, which is more suitable for the present techniques. Note that multi-hop information can be obtained in a fully distributed manner (through only local communications between 1-hop neighbors) by only assuming that each sensor has a unique ID in the communication system. In the following section, a GNN architecture that directly aggregates original features from remote neighbors is introduced.

### C. Hybrid GNN for Feature Aggregation

A static sensor network [symbol] ={s₁, . . . ,s_{N}} can be described as an undirected graph [symbol] ( [symbol] , ε), where each node vᵢ∈ [symbol] denotes a sensor sᵢ and each edge (vᵢ,vⱼ)∈ε denotes a communication link between two sensors sᵢ and sⱼ, sⱼ∈ [symbol] ᵢ^{s}. A={Aᵢⱼ}∈ [symbol] ^{N×N} is the adjacency matrix and \tilde{M}∈ [symbol] ^{N×N} is the diagonal degree matrix which is defined as \tilde{M}ᵢᵢ=Σⱼ Ãᵢⱼ, where Ã={Ãᵢⱼ}=A+I_{N}. Then a Graph Convolutional Network (GCN) can be formulated by stacking a series of Graph Convolutional Layers (GCLs) defined as:

$${H}^{( l + 1 )} = σ ( {\tilde{M}}^{- \frac{1}{2}} \tilde{A} {\tilde{M}}^{- \frac{1}{2}} {H}^{( l )} {W}^{( l )} ) , \qquad ( 1 )$$

where H^{(l)}∈ [symbol] ^{N×F}^{ᵢ} is the output feature of the l^{th} GCL, which is also the input of the next layer. W(l)∈ [symbol] ^{F}^{ᵢ}^{×F}^{ᵢ₊₁} is a learnable weight matrix and σ(·) is an element-wise nonlinear activation function.

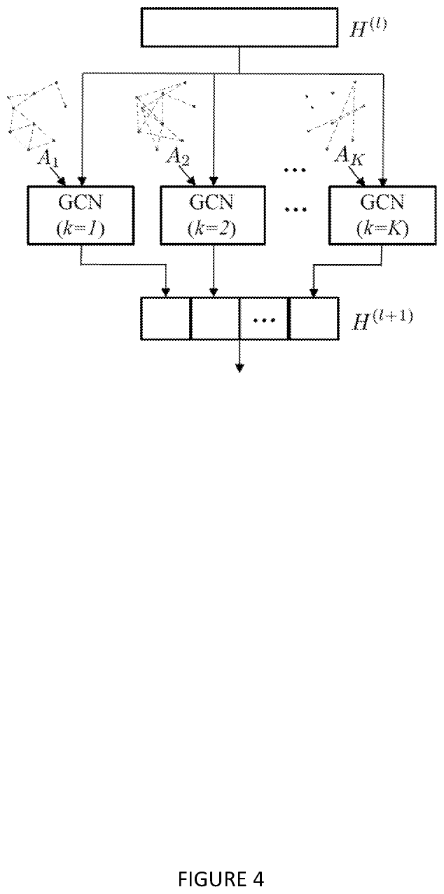

FIG. 4 is a schematic diagram of the graph neural network module. As shown in FIG. 4, GCNs are used as sub-modules in the GNNs of the present techniques. The GCNs aggregate information of the neighbours located in each hop and then mix the aggregated information over various hops to compose the output features. The following hybrid structure is designed:
1) First, various-hop graphs [symbol] ₖ, k=1, . . . ,K are defined to directly represent the relation between k-hop neighbors. Specifically, [symbol] ₁= [symbol] is the original graph. In [symbol] ₖ, k>1, each sensor is directly connected with its k-hop neighbors in g. The following equation Aₖ∈ [symbol] ^{N×N} is defined as the adjacency matrix of [symbol] ₖ and \tilde{M}ₖ∈ [symbol] ^{N×N} as the degree matrix.
2) Then, a hybrid aggregation structure is designed as follows:
   (a) For the first GCL, the initial input feature matrix is defined as H⁽⁰⁾=[z^{S}^{₁}, . . . ,z^{S}^{_{N}}]^{T} (for simplification, the subscript t is removed here), where the i^{th} row is the image feature vector of the sensor sᵢ.
   (b) In the {l+1}^{th} GCL, K parallel GCNs are used to aggregate information in various-hop graphs. The output of the GCN on [symbol] ₖ is

$$σ ( {\tilde{M}}_{k}^{- \frac{1}{2}} {\tilde{A}}_{k} {\tilde{M}}_{k}^{- \frac{1}{2}} {H}^{( l )} {W}_{k}^{( l )} ) ,$$

$$where$$

$${\tilde{A}}_{k} = {A}_{k} + {I}_{N}$$

$$and$$

$${W}_{k}^{( l )} ∈ {ℝ}^{{F}_{l} \times \frac{{F}_{l + 1}}{K}} .$$

Then the output feature of the {l+1}^{th} GCL is defined as the concatenation of the outputs of the K parallel GCNs:

$${H}^{( l + 1 )} = {‖}_{k = \{ 1 , … , K \}} σ ( {\tilde{M}}_{k}^{- \frac{1}{{2}^{}}} {\tilde{A}}_{k} {\tilde{M}}_{k}^{- \frac{1}{{2}^{}}} {H}^{( l )} {W}_{k}^{( l )} ) . \qquad ( 2 )$$

(c) L GCLs are introduced and the output of the GNN-based feature aggregation module is H^{(L)}, in which the feature vector of sensor sᵢ is hₜ^{s}^{ᵢ}.

### D. Stage 1: Target Direction Prediction

An MLP module for each static sensor is used to predict the target object direction. Specifically, the input of the MLP module is the concatenation of the feature hₜ^{s}^{ᵢ} aggregated by a GNN and the original feature zₜ^{s}^{ᵢ} extracted by a CNN. The output is a two dimensional vector [aₜⁱ,βₜⁱ] with the normalization |aₜⁱ|²+|βₜⁱ|²=1, which points out the direction to the target. The true value [āₜⁱ, β̅ₜⁱ] is obtained by using the any-angle A*-based path planning method Theta* (K. Daniel and et. al., “Theta*: Any-angle path planning on grids,” Journal of Artificial Intelligence Research, vol. 39, pp. 533-579, 2010) on the map with static obstacles.

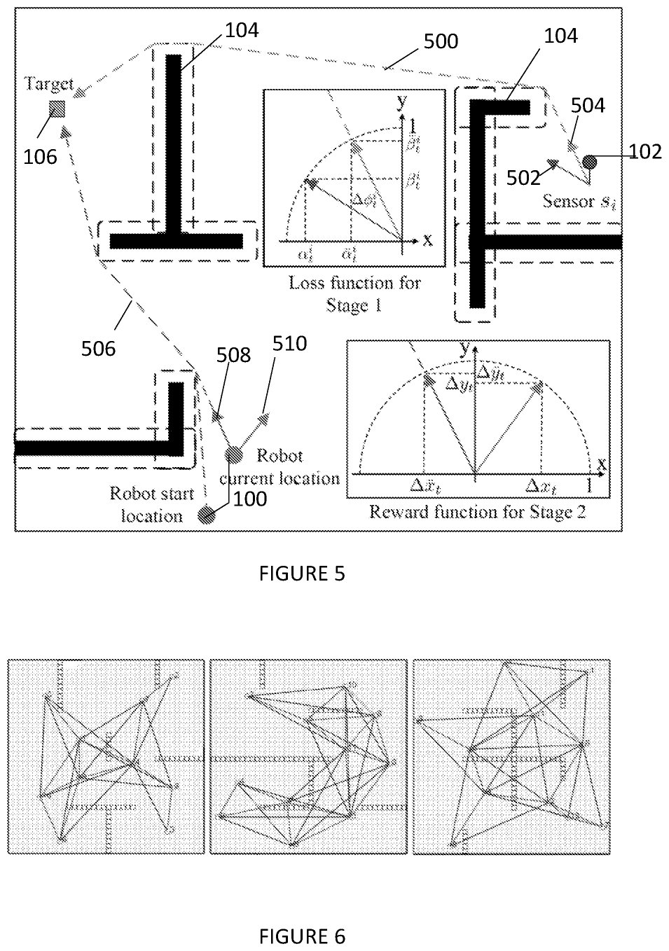

FIG. 5 illustrates the loss function of the first stage and reward function of the second stage. A sensor 102 sᵢ is shown in FIG. 5, as is the target object 106. The initial and current locations of the navigating device 100 (referred to as “robot” in the Figure) are also indicated in FIG. 5. The dashed lines around each static obstacle 104 are used to show that static obstacles 104 are inflated to take account of the size of the navigating device 100. For the loss function, the dotted line 500 represents the optimal A* path. Arrow 504 represents the true target direction from the sensor 102, while arrow 502 represents the predicted target direction from the sensor 102. For the reward function, dotted line 506 represents the optimal A* path, which is calculated in the initialization of each instance and is fixed during movements of the navigating device 100. Arrow 508 represents the expected moving direction of the navigating device 100, and arrow 510 represents the real moving direction of the navigating device. The zoomed sub-figures show that the directions are normalised into Unit circles to obtain their components on X-axis and Y-axis, and then the differences between the corresponding components are evaluated to calculate the loss and reward.

As shown in FIG. 5, the loss for sensor sᵢ is defined as:

[symbol]

ₜⁱ=(āₜⁱ−aₜⁱ)²+(β̅ₜⁱ−βₜⁱ)², (3)

and the final loss function [symbol] ₜ=Σᵢ [symbol] ₜⁱ. Since |aₜⁱ|²+|βⱼⁱ|²=1 and |āₜⁱ|²+|β̅ⱼⁱ|²=1, it can easily be obtained that [symbol] ₜⁱ=2×(1−cos Δϕₜⁱ), where Δϕₜⁱ is the angle between the predicted target direction and its true data. Thus the loss function of the present techniques evaluates the target direction prediction error of each sensor.

### E. Stage 2: Sensor Network Guided Robot Navigation

The CNN and GNN modules trained in Stage 1 are used to initialize model parameters of the navigating device 100, and the target direction prediction module is replaced with another randomly initialized action policy module to further train the whole network of the navigating device 100 in an end-to-end manner. Specifically, at each time t, the navigating device 100 is added to the sensor network and the adjacency matrix Aₖ∈ [symbol] ^{(N+1)×(N+1)}, k=1, . . . ,K is re-generated based on the current location of the navigating device. As shown in FIG. 3, the GNN-aggregated feature hₜ^{R} and the original CNN feature zₜ^{R} are concatenated, and the policy network is used to generate robot action aₜ. RL is used with the following reward function [symbol] ₜ:

$$\{ \begin{matrix}if {q}_{t + 1}^{R} ∈ 𝒞 , & {ℛ}_{t} = - {R}_{1} ; \\ elseif L ( {q}_{t + 1}^{R} , {q}^{Target} ) \leq δ , & {ℛ}_{t} = {R}_{2} ; \\ else , & {ℛ}_{t} = - 𝒟 ( {a}_{t} , {\overline{a}}_{t} ) - {R}_{3} ,\end{matrix} \qquad ( 4 )$$

where q^{Target} is the target location, aₜ=[Δxₜ,Δyₜ] is the actual robot action and āₜ=[Δx̅ₜ, Δy̅ₜ] is the expected one, [symbol] (aₜ, āₜ)=\sqrt{(Δxₜ−Δx̅ₜ)²+(Δyₜ−Δy̅ₜ)²}, qₜ₊₁^{R} is the robot location after taking the action aₜ and L(qₜ₊₁^{R},q^{Target}) is the Euclidean distance between the robot's next location and the target, δ is a predefined distance bound, and R₂>R₁>R₃>0. Here, Theta* is also used to generate the optimal path from the robot initial location to the target at the start of each run in training, then at each step t, at is defined as moving one unit distance to the next turning point on the optimal path (as shown in FIG. 5). Note that no imitation learning strategy is introduced in Stage 2 as it is not required for the robot to strictly follow the optimal path. The optimal path information is only utilized in the reward function of the present techniques to provide a dense reward at each time step that encourages the robot to move to the target direction.

The detailed network architecture, RL algorithm, training and testing parameters, baseline approaches and evaluation metrics are now introduced.

Network Architecture. The network follows a CNN-GNN-MLP structure, as shown in FIG. 3. For the CNN part, a ResNet structure is used with four residual blocks to extract visual features. The network inputs are in the dimension of B×N×W×H×3, where the batch size B=64 and the sensor number N is set from 10 to 16 based on different sensor layouts. The dimension of the omnidirectional image is W×H=84×336, three R/G/B channels are considered. For the GNN part, K=4 is set and each branch has 128 channels, i.e., Fₗ=512, l=0, . . . ,L. The network is tested with different layer numbers L for comparison. For the MLP part, in Stage 1, three FC layers are used. The first one has 256 units and the second one has 64 units. Both layers are followed with ReLU (Rectified Linear Unit) activation function and the last layer has 2 units with Linear activation function. In Stage 2, the robot/navigating device has the same network structure, but the MLP part is re-initialized.

RL Algorithm. Proximal Policy Optimization (PPO) is used for RL. PPO is described in J. Schulman and et. al., “Proximal policy optimization algorithms,” 2017. After acquiring the reward, PPO calculates the following loss:

Lₜ^{CLIP}(θ)=Êₜ[min(γₜ(θ)\hat{P}ₜ,clip(γₜ(θ),1−ε,1+ε)\hat{P}ₜ)] (5)

where θ is the policy parameter, Êₜ is the empirical expectation over time steps, γₜ is the ratio of the probability under the new and old policies respectively, \hat{P}ₜ is the estimated advantage at each time step t, and the hyper-parameter ε=0.2.

Training and Testing. For Stage 1, 18 maze-like training maps are built with a size of 40×40. In each map, 30 different sensor layouts are generated, i.e., 540 training layouts are used in total. In each layout, the sensor number N is randomly set from 9 to 13. For the first N−2 sensors, the minimum distance between any two sensors which can see each other directly is ensured to be larger than 10, and the location of the last two sensors is randomly generated. The communication range is Dₛ=15, the communication graph of each layout is ensured to be connected, and it is ensured that more than 80% area in the map is covered by the communication range of the sensor network (i.e., if the robot locates within this area, it can communicate with at least one sensor).

FIG. 6 shows example maps and sensor layouts used to train the ML model. In order to alleviate overfitting on sensor layouts and simulate the moving robot in Stage 2, a novel training procedure called dynamic training is applied. Concretely, in each training epoch of Stage 1, first one of the 540 layouts is selected randomly, and then Nₐ sensors are added with random locations, where Nₐ is randomly chosen from 1 to 3. So the total sensor number used in each training epoch is a random number with the range from 10 to 16. Then 100 training configurations are generated with random target locations. The maximum number of training epochs is 20K, i.e., 20K different training layouts are obtained and the total number of training configurations is 2 M.

For Stage 2, one sensor layout is randomly selected from each of the 18 training maps, to give 18 sensor layouts in total. A fixed number of sensors N=9 is kept in each layout and the connectivity and 80% coverage is guaranteed. In each episode, one of the 18 layouts is randomly chosen with randomly generated target location, and then Nₐ dynamic sensors are added, where Nₐ is also randomly chosen from 1 to 3. If the robot reaches the target object within the bound δ=1 or the number of training steps in an episode exceeds 512, this episode is ended. The maximum number of training episode is 20K. Reward parameters in Equation 4 are set to R₁=1, R₂=10 and R₃=0.1. The initial learning rate at both stages is 3 e⁻⁵. Moreover, the learning rate in Stage 1 is scheduled by a factor of 10 at every quarter of the maximum epoch.

In the inference stage of Stage 1, a similar approach is used to randomly generate 3 unseen maps; for each, there are 3 sensor layouts, and the sensor number N is set to 10 or 11. For each sensor layout, there are 100 cases with random (but fixed) robot and target locations, i.e., 900 different testing configurations are prepared. In the inference stage of Stage 2, 9 unseen maps with fixed sensor layouts (9 sensors) are randomly generated. For each unseen map, 100 cases with random target and robot initial locations are generated. The robot is required to navigate from its initial location to the target. In order to solve the failure cases that the robot is continuously blocked by a static obstacle, a heuristic operation called heuristic moving is introduced in the testing of Stage 2. Concretely, if the robot's next action leads to a collision with static obstacles, the output velocity is ignored in the orthogonal direction to the nearest static obstacle and only output the velocity in the tangential direction. In addition, a small probability that the robot randomly chooses a collision-free action when it has stayed in its current location for more than three steps is introduced.

Comparison networks. In the framework of the present techniques, the GNN-based feature aggregation module has a critical role. In order to evaluate different GNNs in an ablation analysis, the following 9 structures are compared:
GNN2, GNN3 and GNN4: The hybrid GNN presented in Section C above with L=2, 3 or 4 layers.
GNN2 w. Skip: The hybrid GNN presented in Section C above with 2 layers but without the skip-connection of the CNN features, i.e., the GNN-aggregated feature is directly used as the input of the MLP module.
DYNA-GNN2, DYNA-GNN3 and DYNA-GNN4: The hybrid GNN presented in Section C above with L=2, 3 or 4 layers, and the dynamic training is introduced.
DYNA-GAT2 and DYNA-GAT4: The GCN layers are replaced in the low level of the hybrid GNN, with the Graph Attention Networks (GAT) (P. Velickovic and et. al., “Graph Attention Networks,” 2018), and the mix-hop structure is retained in the high-level with L=2 or 4 layers. The dynamic training is introduced

In addition, the following approaches are compared to validate the necessity of introducing Stage 1 in the present techniques:
E2E-NAV: All the sensors are removed, and the CNN-MLP structure is implemented, which is learned from scratch by using the robot's visual inputs and the same reward function provided in Section E above.
E2E-GNN-NAV: The same sensor configurations and the same CNN-GNN-MLP structure are used, which is learned from scratch without the introduction of Stage 1. In addition, the model is trained without the introduction of dynamic training.
OURS: The CNN-GNN-MLP structure of the present techniques is used, which is trained with dynamic training.
OURS-H: The CNN-GNN-MLP structure of the present techniques is used, which is trained with dynamic training. In addition, heuristic moving is introduced in testing.

Metrics. The following metrics are considered:
Angle Error: For the target direction prediction task in Stage 1, the angle error Δϕₜⁱ defined in Section D above is calculated as the performance metric.
Success Rate: In Stage 2, a time-out of 100 moving steps is set for all the tests; within this time, if the robot cannot reach the target, this test is defined as a failure case. Then the success rate on each map is counted.
Detour Percentage:

$$Detour = \frac{{ℒ}_{r} - {ℒ}_{{A}^{*}}}{{ℒ}_{{A}^{*}}} \times 1 \; 00 \% , \qquad ( 6 )$$

where [symbol] ᵣ is the actual moving distance of the robot in Stage 2 and [symbol] _{A*} is the length of the optimal A* path.
Moving Step:

$$Mov . Step = \frac{{ℳ}_{r}}{{ℒ}_{{A}^{*}}} , \qquad ( 7 )$$

where [symbol] ᵣ is the number of actual moving steps of the robot in Stage 2 and [symbol] _{A*} is used as a normalizing factor.
The Detour Percentage and Moving Step are calculated by only considering the successful cases.

Results. In this section, the results for both stages are provided.

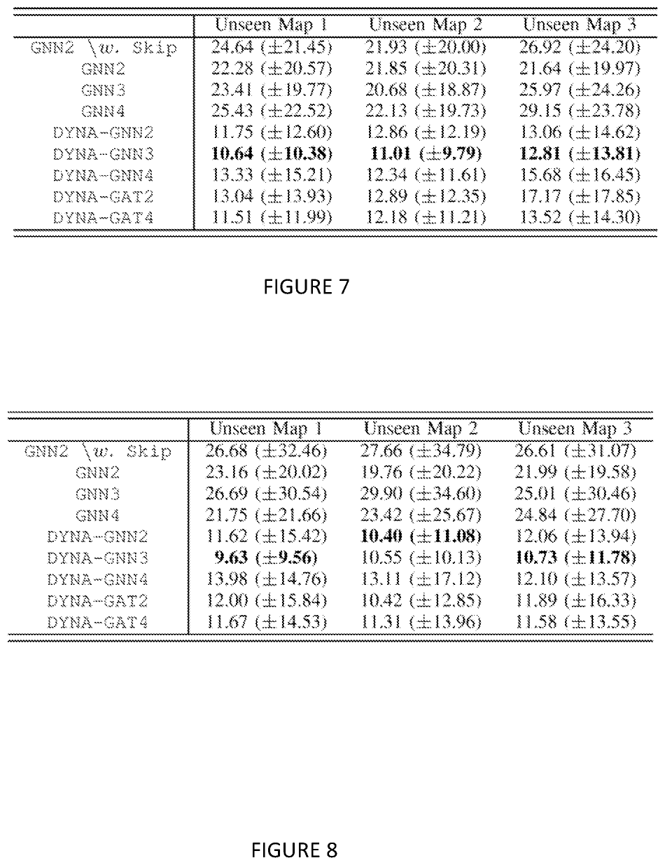

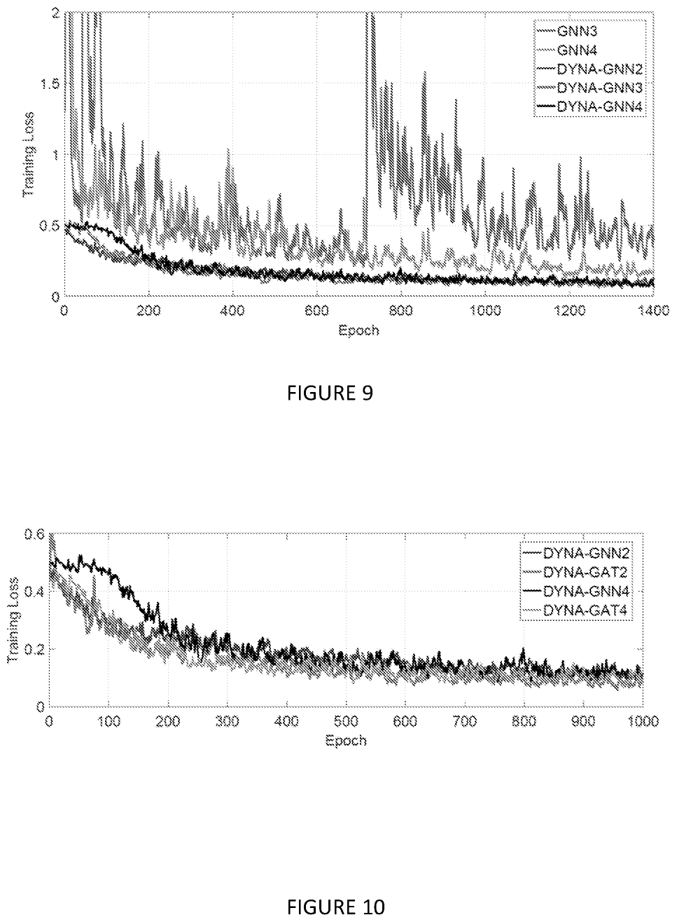

Target Direction Prediction. For Stage 1, all the GNN structures defined above in the Comparison Networks section are tested with the same CNN and MLP modules. FIG. 7 is a table showing an average angle error of all the sensors in each unseen map of the target prediction task. FIG. 8 is a table showing an average angle error of the robot in each unseen map of the target prediction task. In each table, the values are listed as “mean (±standard deviation)” across 3 layouts with 100 instances in each. The lowest (best) values are highlighted in bold. The training loss of different GNNs are shown in FIGS. 9 and 10. Specifically, FIG. 9 is a graph comparing the training loss with and without dynamic training, and FIG. 10 is a graph comparing the training loss with and without graph attention networks, GAT.

In Stage 1, the robot is also seen as a static sensor (but with random locations) to test its target prediction ability. The table in FIG. 7 shows the target direction prediction results of all the sensors while the table in FIG. 8 shows the results of the robot.

The above results show that: 1) Introducing the skip-connection of the CNN features greatly improves the target direction prediction performance. A possible reason is that the GNN module can concentrate on the information sharing and aggregation without additionally having to learn to pass on local visual features from the CNN module which are also critical for the target prediction task. 2) Introducing dynamic training greatly accelerates the convergence speed in training and improves the final prediction performance. 3) Adding more GNN layers does not largely improve the performance (and even slightly decreases the convergence speed in the initial training stage). 4) Adding an attention mechanism does not improve the performance. A possible reason is that, in the task of the present techniques, the feature of the sensor that can directly see the target should be given more attention in the feature aggregation process. However, without any specified pre-training, it is very hard for the network to learn this information. However, adding the attention mechanism slightly improves the convergence speed in the initial training stage. 5) DYNA-GNN3 achieves the best performance in most cases; the average target prediction error in each map is roughly 10 degrees, which is accurate enough for guiding the robot navigation. In the following sections, DYNA-GNN3 is used as the default GNN structure.

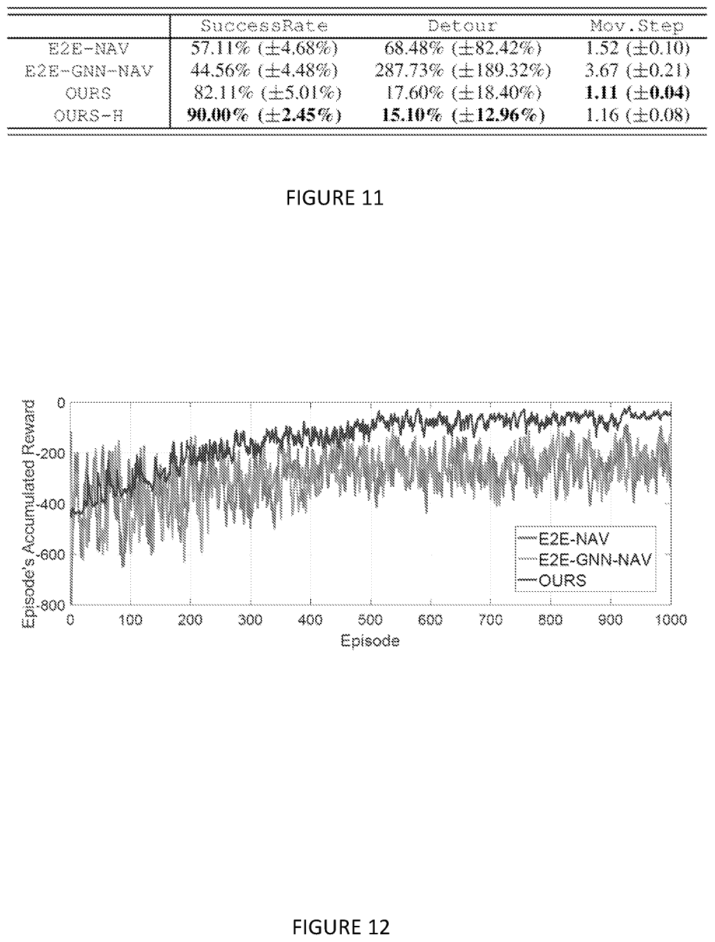

Robot Navigation. For Stage 2, different methods defined in the Comparison Networks section above are tested to evaluate their performance. FIG. 11 is a table showing the results of robot navigation. In the table, the values are listed as “mean (±standard deviation)” across 3 layouts with 100 instances in each. The best values are highlighted in bold. FIG. 12 is a graph comparing the training reward provided in the second stage by the different approaches. The final robot navigation performance shown in the table in FIG. 11 demonstrates that: 1) Compared with end-to-end methods, introducing the target prediction stage in the approach of the present techniques contributes to largely improved robot navigation performance in unknown environments. In addition, introducing heuristic moving presented above further improves the Success Rate to 90%. Note that the methods of the present techniques only input the first-person-view visual images and no global positioning information of the target, obstacles or sensors is introduced. The obtained results are very promising for large-scale applications in complex environments; 2) For E2E-NAV, the robot has no chance to obtain any target information if it cannot see the target directly; both the Success Rate and Detour Percentage are worse than the method of the present techniques. 3) Comparing E2E-NAV and E2E-GNN-NAV, it can be seen that introducing sensor information and GNN-based feature aggregation does not improve the performance and even makes it much worse. The reason is that, without a clear message (such as a specified reward function), the robot cannot learn how to use the information shared by sensors and how to make decisions by balancing its own observations with the shared features.

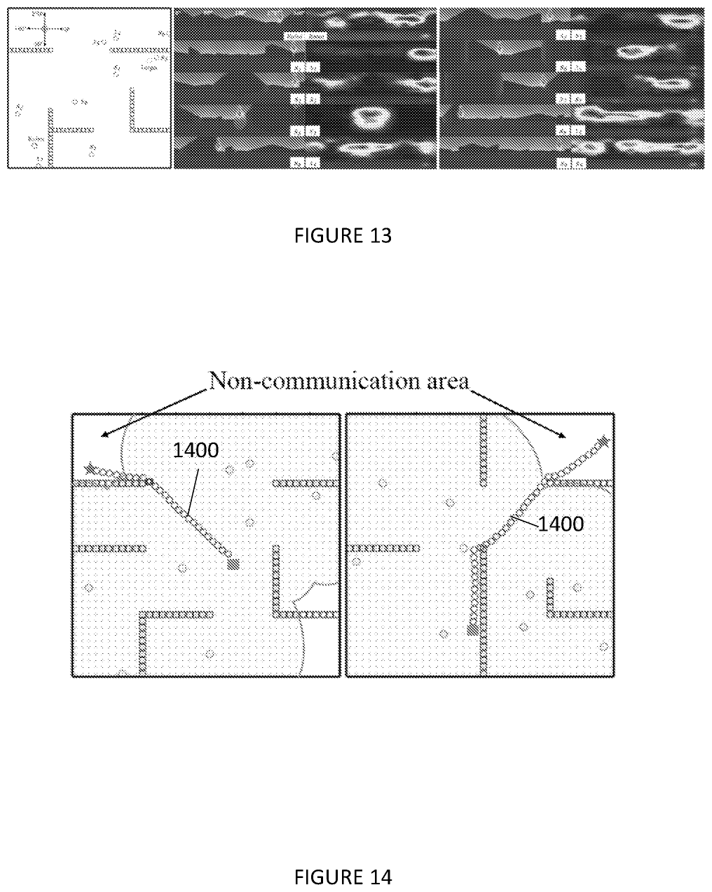

FIG. 13 is a visualisation for interpreting robot control policy. Here, the parts of the robot's own input image and sensors' images which contribute most to the robot's final action are visualised. Specifically, the gradient of input visual features on the final output of the robot's policy network are calculated, and the heat-value of each pixel in the input images is plotted. The left figure shows the static obstacle, sensor, robot, and target object. The coordinate of the omnidirectional input images is shown in the upper-left. The middle and right figures show the visualization results, where the left columns show the original input images and the right columns show the heat-value of each corresponding pixel in the original input images. The arrow plotted on each input image points out the true direction of the optimal A* path from the robot/sensor location to the target. The deep red areas on the heat figures contribute most to the robot's chosen action, while the deep blue areas contribute the least.

FIG. 13 shows an example of the visualization results, which demonstrates that: 1) The area with the largest heat-value in each heat figure is consistent with the true direction of the optimal A* path. This validates that the network of the present techniques has learned how to extract effective target features (if the target can be seen directly) or predict the target direction by effectively aggregating the shared information (if the target cannot be seen directly). Note that the robot, in this case, cannot see the target directly, but the network of the present techniques has successfully learned the true target direction. 2) The directions which correspond to the paths to invisible areas are also highlighted; this validates that the network of the present techniques has learned an effective ‘exploration’ policy that gives more attention to the areas with high target probabilities. 3) Except for the above key information for the robot navigation task, other redundant information is ignored (with low heat-values), which demonstrates the effectiveness of the information sharing and information aggregation capabilities of the network of the present techniques.

FIG. 14 illustrates a case where a robot is unable to communicate with the sensor network. Here, two typical cases with communication disconnections in the initial robot navigation stage of our approach are visualised. In each case, the star shows the initial location of the navigating device/robot, while the square represents the location of the target object. The line of circles 1400 shows the real robot path. The shaded area shows the communication range of the sensor network.

The results show that, in the absence of any target information and network information, the robot moves towards the center of the map without any detours; this indicates that the network of the present techniques has learned an effective ‘exploration’ policy that gives more attention to the direction with high probability to see the target and connect with the sensor network. Finally, when the robot enters the communication range of the sensor network, it proceeds by moving to the target directly with the help of the shared information from the sensor network.

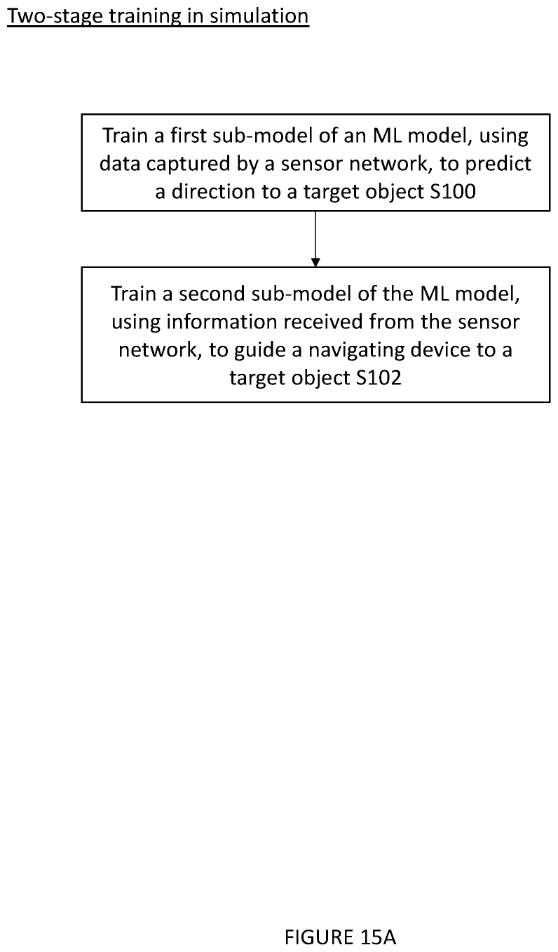

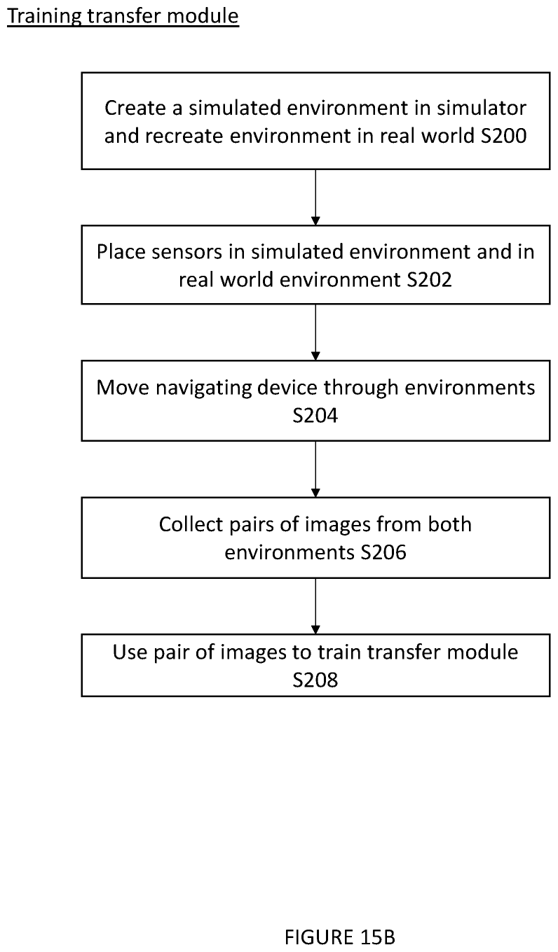

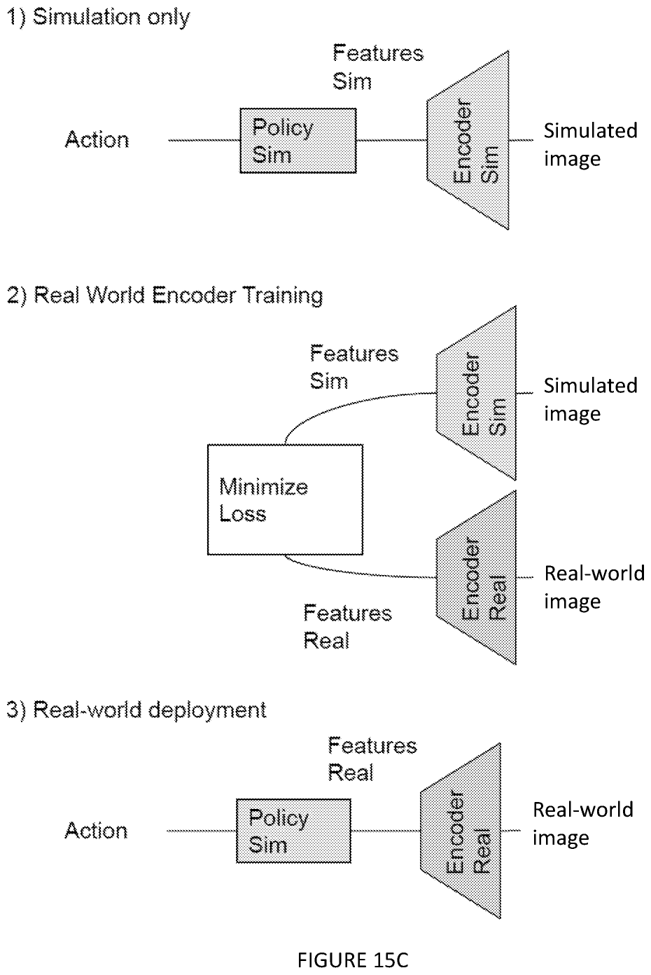

FIG. 15A is a flowchart of example steps to train the ML model for a navigation system comprising a navigating device 100 and a sensor network comprising a plurality of static sensors 102 that are communicatively coupled together (i.e. a communication topology of the sensor network is connected). The training may be performed in a simulator which simulates a real-world environment.

The method comprises training neural network modules (e.g. an encoder) of a first sub-model of the ML model to predict, using data captured by the plurality of static sensors 102, a direction corresponding to a shortest path to a target object 106, wherein the target object 106 is detectable by at least one static sensor 102 (step S100). It will be understood that the shortest path is the shortest obstacle-free path. That is, the shortest path will likely involve navigating around any static obstacles in the environment

The method comprises training neural network modules of a second sub-model of the ML model to guide, using information shared by the sensor network, the navigating device 100 to the target object 106 (step S102).

Training in the real-world is generally unfeasible due to the difficulty in obtaining sufficient training data and due to sample-inefficient learning algorithms. Thus, the training described herein may be performed with non-photorealistic simulators. However, photorealistic simulations are challenging to realise and expensive. As a result, a model trained in a non-photorealistic simulator may not function correctly or as accurately when the trained model is deployed in the real-world. Thus, the present techniques also provide a technique to facilitate the transfer of the policy trained in simulation directly to a real navigating device to be deployed in the real world. Advantageously, this means that the whole model does not need to be retrained when the navigation system is deployed in the real world, which can speed-up the time to prepare the system for real world use. FIG. 15B is a flowchart of example steps to train a transfer module. This method facilitates the transfer of the policy trained in simulation to the real-world. One way to solve the above-mentioned problem is to transform real world images into images that look like they were generated in simulation, and then run the policy on those images. The present techniques take a different approach and extend the simulation-only pipeline with an additional supervised learning step. The present techniques collect image pairs from simulation and corresponding images from the real world. A first image encoder trained in simulation on simulated images is run to obtain a feature vector. A second image encoder is trained on real world images to replicate the feature vector generated in simulation. Finally, this feature vector, which is indistinguishable from the features of the simulated image, is provided to the policy trained in simulation.

The method comprises creating a simulated environment in a simulator and recreating the same simulated environment in the real world (step S200). Static sensors are placed in the simulated environment and real world environment in the same locations (step S202). The navigating device is then moved through each environment in the same way (step S204), and data-pairs are collected from each sensor as the navigating device moves through the environments (step S206). When the static sensors are image sensors, the data-pairs may be pairs of images. The data-pairs form a dataset that may be used to train a transfer module (e.g. the second image encoder). The data-pairs are then used to train the transfer module (step S208) as shown in FIG. 15C. The training comprises training the transfer module to map the real-world sensor data to the latent encoding (e.g. feature vector) generated by the neural network modules (e.g. first image encoder) of the first sub-model of the ML model that has been trained in the simulation (as described above with reference to FIG. 15A, for example). In this way, it is possible to train the first sub-model of the ML model entirely in simulation using reinforcement learning, and to train an independent ‘real-to-sim’ transfer module using supervised learning.

When the navigating device is to be deployed in the real world, one or more neural network modules of the first sub-model that have been trained in simulation may be replaced with one or more neural networks of the transfer module that have been trained with real-world images.

FIG. 15C is a schematic diagram illustrating the training step of FIG. 15B. As shown in FIG. 15C, an encoder may only be trained using simulated images, but then it may not perform well on real-world images. Thus, a first encoder may be trained in the simulated environment on the simulated images of the data-pairs, and a second encoder may be trained on the real-world images of the data-pairs. The second encoder may be trained to replicate the feature vector generated by the first encoder. The training may be supervised training to minimise a loss. In this way, the learning from the simulated environment is transferred to the second encoder. The second encoder may then be deployed in the real-world.

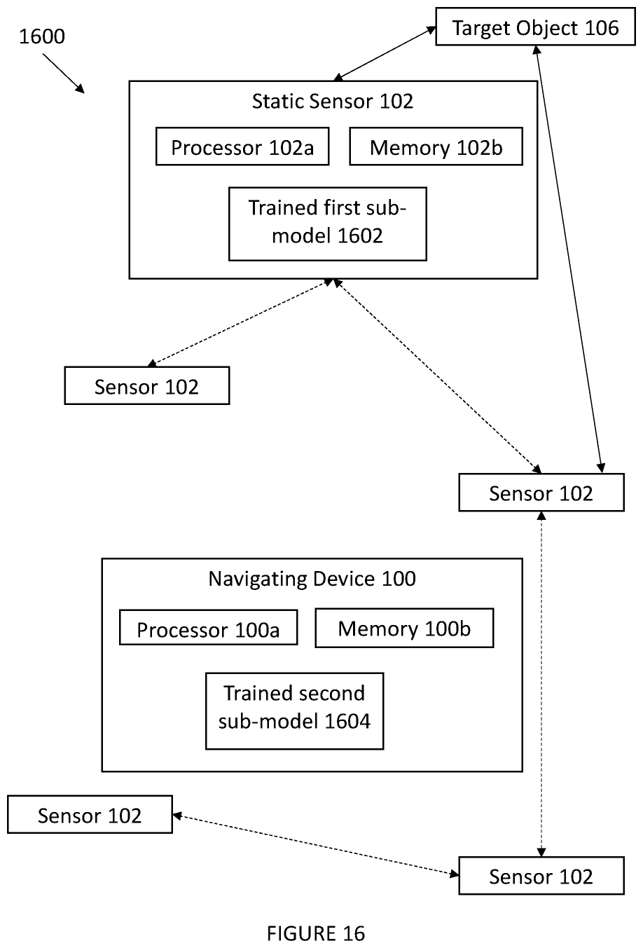

FIG. 16 is a block diagram of a navigation system 1600. The navigation system 1600 comprises a sensor network comprising a plurality of static sensors 102. The exact number of static sensors 102 may vary depending on the size of the environment to be explored by the navigation system and the communication range of each sensor, for example. In FIG. 16, five static sensors 102 are shown, but it will be understood that this is merely illustrative and non-limiting. More generally, the navigation system 1600 may have any number of static sensors.

The navigation system 1600 comprises a target object 106.

The navigation system 1600 comprises a navigating device 100. The navigating device 100 may be a controlled or autonomous navigating robot, or may be a navigating device that could be held by a human and used by the human to move towards a target object.

Each static sensor 102 comprises a processor 102a coupled to memory 102b. The processor 102a may comprise one or more of: a microprocessor, a microcontroller, and an integrated circuit. The memory 102b may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example. Each static sensor 102 comprises a trained first sub-model 1602 of the ML model. Each static sensor 102 may store the trained first sub-model 1602 in storage or memory.

The plurality of static sensors 102 in the sensor network are communicatively coupled together. This is indicated in FIG. 16 by the dashed arrows between sensors 102. It can be seen that each sensor 102 is able to communicate with every other sensor directly or indirectly. Indirect communication means that a sensor is able to communicate with another sensor in the sensor network by transmitting messages via one or more other sensors. Each static sensor 102 is unable to predict a direction from the static sensor 102 to the target object 102 using its own observations only. Therefore, preferably, a communication topology of the plurality of static sensors 102 in the sensor network is connected.

Each static sensor 102 is able to transmit data captured by the static sensor to the other static sensors in the sensor network. This enables each static sensor to predict a direction from the static sensor to the target object, as each static sensor is able to combine information captured by other static sensors with information captured by itself to make the prediction. In some cases, the data transmitted by the static sensor 102 to other sensors in the sensor network is raw sensor data captured by the static sensor. Preferably, particularly in the case of visual sensors where the data captured by the sensors may have a large file size that may not be efficient to transmit, the data transmitted by the static sensor may be processed data. For example, in the case of visual sensors, features may be extracted from the images captured by the sensors, and the extracted features are transmitted to other sensors. This increases efficiency and avoids redundant information (i.e. information that will not be used to make the prediction) being transmitted.

The static sensors 102 of the sensor network may be any suitable type of sensor. Preferably, the static sensors are all of the same type, so that each sensor can understand and use the data obtained from the other sensors. For example, the static sensors may be audio or sound based sensors. In another example, the static sensors may be visual sensors. In yet another example, the static sensors may be smell or olfactory sensors (also known as “electronic noses”) capable of detecting odours. Any type of static sensor may be used, as long as the target object 106 is detectable by at least one of the static sensors 102 using its sensing capability.

The plurality of static sensors 102 may be visual sensors capturing image data. In this case, the target object 106 is in line-of-sight of at least one static sensor 102.

The processor 102a is arranged to use the trained first sub-model 1600 of a machine learning, ML, model to: predict a direction corresponding to a shortest path to a target object 106, wherein the target object 106 is detectable by at least one static sensor 102.

The navigating device 100 is communicatively coupled to at least one static sensor 102 while the navigating device moves towards the target object 106. In other words, the navigating device is able to communicate with the sensor network. In FIG. 16, the navigating device 100 may be able to communicate with at least the sensors that are close to the navigating device. The navigating device may obtain information from at least one static sensor (e.g. a static sensor that is in communication range with/detectable by the navigating device). The information may comprise the predicted direction from that static sensor to the target object. Preferably, the information sent from the static sensors 102 may not include the predicted target direction—instead, the navigating device 100 may itself estimate the direction from its location to the target object using the information received from the static sensors. Either way, this enables the navigating device 100 to determine which direction it needs to move in. In this way, the navigating device 100 is guided by the information received from each static sensor towards the target object 106.

The navigating device 100 comprises a processor 100a coupled to memory 100b. The processor 100a may comprise one or more of: a microprocessor, a microcontroller, and an integrated circuit. The memory 100b may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example. The navigating device 100 comprises a trained second sub-model 1604 of the ML model. The navigating device 100 may store the trained second sub-model 1604 in storage or memory.

The processor 100a of the navigating device 100 is arranged to use the trained second sub-model 1604 of the machine learning, ML, model to: guide the navigating device 100 to the target object 106 using information shared by the sensor network.

Advantageously, as described above, the present techniques provide an RL-based navigation approach in unknown environments with first-person-view data shared by a low-cost sensor network. The learning architecture contains a target direction prediction stage and a visual navigation stage. The results show that an average target direction prediction accuracy of 10 degrees can be obtained in the first stage, and an average success rate of 90% can be achieved in the second stage with only 15% path detour, which showed to be much better than baseline approaches. In addition, the control policy interpretation results validate the effectiveness and efficiency of the GNN-based information sharing and aggregation in our method. Finally, robot navigation results in the presence of uncovered areas demonstrate the robustness of the method of the present techniques to temporary communication disconnections.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1-20. (canceled)

21. A computer-implemented method of training a machine learning, ML, model for a navigation system comprising a navigating device and a sensor network comprising a plurality of static sensors that are communicatively coupled together, the method comprising:
training neural network modules of a first sub-model of the ML model to predict, using data captured by the plurality of static sensors, a direction corresponding to a shortest path to a target object, wherein the target object is detectable by at least one static sensor; and
training neural network modules of a second sub-model of the ML model to guide, using information received from the plurality of static sensors, the navigating device to the target object.

22. The method as claimed in claim 21 wherein training the neural network modules of the first sub-model to predict the direction comprises:
extracting information from the data captured by each static sensor in the sensor network; and
predicting, using a graph neural network, GNN, module of the first sub-model and the extracted information, the direction corresponding to the shortest path to the target object.

23. The method as claimed in claim 22 further comprising:
defining a set of various-hop graphs representing relations between the static sensors of the sensor network, where each graph of the set of graphs shows how each static sensor is connected to other static sensors that are a predefined number of hops away.

24. The method as claimed in claim 23 wherein the GNN module comprises graph convolutional layer, GCL, sub-modules, and wherein using a GNN module to predict the direction comprises:
aggregating, using the GCL sub-modules, the extracted information obtained from data captured by the static sensors in each various-hop graph; and
concatenating the extracted information and the aggregated extracted information for each static sensor.

25. The method as claimed in claim 22 wherein the plurality of static sensors are visual sensors capturing image data, and the target object is in line-of-sight of at least one static sensor, and wherein:
extracting information comprises performing feature extraction on image data captured by the plurality of static sensors, using a convolutional neural network, CNN, module of the first sub-model.

26. The method as claimed in claim 25 wherein:
aggregating the extracted information comprises aggregating features extracted from images captured by neighbouring static sensors, and extracting fused features from the images of each static sensor, using the GNN module of the first sub-model; and
concatenating comprises concatenating the extracted features and the aggregated features for each static sensor.

27. The method as claimed in claim 24 further comprising:
inputting the concatenation for each static sensor into a multi-layer perceptron, MLP, module of the first sub-model; and
outputting, from the MLP module, a two-dimensional vector for each static sensor which predicts the direction corresponding to the shortest path from the static sensor to the target object.

28. The method as claimed in claim 21 wherein training the neural network modules of the second sub-model to guide the navigating device is performed after the neural network modules of the first sub-model have been trained to predict the direction.

29. The method as claimed in claim 28 further comprising:
initialising parameters of the second sub-model using the trained neural network modules of the first sub-model and by considering the navigating device to be an additional static sensor within the first sub-model; and
applying reinforcement learning to train the second sub-model to guide the navigating device to the target object.

30. The method as claimed in claim 29 wherein applying reinforcement learning comprises using the predicted direction to reward the navigating device, at each time step, to move in a direction corresponding to the predicted direction.

31. The method as claimed claim 21 wherein the neural network modules of the first and second sub-models are trained in a simulated environment.

32. The method as claimed in claim 31 further comprising training a transfer module using a training dataset comprising a plurality of pairs of data, each pair of data comprising data from a static sensor in the simulated environment and data from a static sensor in a corresponding real world environment.

33. The method as claimed in claim 32 further comprising replacing one or more of the neural network modules of the first sub-model of using corresponding neural network modules of the transfer module.

34. A non-transitory machine readable media having instructions stored thereon, the instructions configured to cause a processor to train a machine learning, ML, model for a navigation system comprising a navigating device and a sensor network comprising a plurality of static sensors that are communicatively coupled together, by:
training neural network modules of a first sub-model of the ML model to predict, using data captured by the plurality of static sensors, a direction corresponding to a shortest path to a target object, wherein the target object is detectable by at least one static sensor; and
training neural network modules of a second sub-model of the ML model to guide, using information received from the plurality of static sensors, the navigating device to the target object.

35. A navigation system comprising:
a sensor network comprising a plurality of static sensors, wherein each static sensor comprises a processor, coupled to memory, arranged to use a trained first sub-model of a machine learning, ML, model to:
predict a direction corresponding to a shortest path to a target object, wherein the target object is detectable by at least one static sensor; and
a navigating device comprising a processor, coupled to memory, arranged to use a trained second sub-model of the machine learning, ML, model to:
guide the navigating device to the target object using information received from the plurality of static sensors.

36. The navigation system as claimed in claim 35 wherein the plurality of static sensors in the sensor network are communicatively coupled together.

37. The navigation system as claimed in claim 36 wherein a communication topology of the plurality of static sensors in the sensor network is connected.

38. The navigation system as claimed in claim 35 wherein each static sensor transmits data captured by the static sensor to the static sensors in the sensor network, thereby enabling each static sensor to predict a direction from the static sensor to the target object.

39. The navigation system as claimed in claim 35 wherein the navigating device is communicatively coupled to at least one static sensor while the navigating device moves towards the target object.

40. The navigation system as claimed in claim 35 wherein the plurality of static sensors are visual sensors capturing image data, and wherein the target object is in line-of-sight of at least one static sensor.
